(19) United States
(12) Patent Application Publication
(10) Pub. No.: US 2026/0180972 A1
(43) Pub. Date: Jun. 25, 2026

(54) INFORMATION PROCESSING APPARATUS, AUTHENTICATION SERVER, SYSTEM, INFORMATION PROCESSING METHOD, AND NON-TRANSITORY COMPUTER-READABLE STORAGE MEDIUM

(71) Applicant: CANON KABUSHIKI KAISHA, Tokyo (JP)

(72) Inventors: Sei FUJIWARA, Tokyo (JP); Atsushi NOGAMI, Kanagawa (JP)

(21) Appl. No.: 19/422,609

(22) Filed: Dec. 17, 2025

(30) Foreign Application Priority Data
Dec. 19, 2024 (JP) 2024-224304

(51) Int. Cl. H04L 9/40

(52) U.S. Cl. CPC H04L 63/0807; H04L 63/1425; H04L 2209/608

(57) ABSTRACT

An information processing apparatus that holds a generated output generated by generative artificial intelligence (AI) processing, the information processing apparatus comprises an acquisition unit configured to acquire, from an outside, authentication information regarding an authenticated truthfulness score, which is a result of authentication of truthfulness score of the generated output; and a holding control unit configured to hold an authenticated truthfulness score based on the authentication information in association with a generated output.

### BACKGROUND

### Field of the Technology

The present disclosure relates to generative AI.

### Description of the Related Art

In recent years, with the spread of generative artificial intelligence (AI), an environment in which individuals can easily generate a large amount of a wide variety of data (such as text, images, moving images, audio, and 3D models) has been developed. Data creation by such generative AI is considered to be further utilized in the future.

On the other hand, generated outputs generated by the generative AI may include information not based on facts or information greatly altered from facts. Therefore, information indicating the reliability of the generated output is required.

Regarding this technology, US-2024-0073478 discloses a technology of identifying a source of a moving image by comparing visual and audio features extracted by inputting a target video into a neural network with features of a known video, in order to determine whether the moving image has been edited.

Japanese Patent Laid-Open No. 2022-58696 discloses a technology for determining truthfulness score of a character generated by an adversarial network model being learned in order to perform character generation using the model.

In the technology of US-2024-0073478 described above, the source of the generated output by the generative AI is recorded in metadata, but the truthfulness score is not handled. In the technology of Japanese Patent Laid-Open No. 2022-58696, the reliability of the truthfulness score is not sufficient for the generated output of the generative AI. The above-described technology has failed to provide a highly reliable truthfulness score for the generated output of the generative AI processing.

### SUMMARY

Therefore, in order to solve the above problems, the present disclosure provides a technology that can improve the reliability of truthfulness score of a generated output by generative AI processing.

The present disclosure in its first aspect provides an information processing apparatus that holds a generated output generated by generative artificial intelligence (AI) processing, the information processing apparatus comprising: an acquisition unit configured to acquire, from an outside, authentication information regarding an authenticated truthfulness score, which is a result of authentication of truthfulness score of the generated output; and a holding control unit configured to hold an authenticated truthfulness score based on the authentication information in association with a generated output.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a conceptual view of a generative AI system according to a first embodiment.

FIG. 2 is a block diagram illustrating a module configuration of a client according to the first embodiment.

FIG. 3 is a block diagram illustrating a module configuration of an authentication server according to the first embodiment.

FIG. 4 is a block diagram illustrating a hardware configuration of an information processing apparatus according to an embodiment.

FIG. 5 is a sequence diagram of a generative AI system according to the first embodiment.

FIG. 6 is a flowchart showing a processing procedure of an authentication server according to the first embodiment.

FIG. 7 is a conceptual view of a generative AI system according to a second embodiment.

FIG. 8 is a block diagram illustrating a module configuration of a client according to the second embodiment.

FIG. 9 is a block diagram illustrating a module configuration of an authentication server according to the second embodiment.

FIG. 10 is a sequence diagram of a generative AI system according to the second embodiment.

FIG. 11 is a conceptual view of a generative AI system according to a third embodiment.

FIG. 12 is a block diagram illustrating a module configuration of a client according to the third embodiment.

FIG. 13 is a block diagram illustrating a module configuration of an authentication server according to the third embodiment.

FIG. 14 is a sequence diagram of a generative AI system according to the third embodiment.

FIG. 15 is a flowchart showing a processing procedure of an authentication server according to the third embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment: Authentication by Client and Authentication Server

First, an outline of an environment in which an information processing apparatus according to the first embodiment is used will be described. In the present embodiment, truthfulness score, which is an evaluation score, is calculated for a generated output by generative artificial intelligence (AI) processing, and an authenticated truthfulness score, which is an authentication result of the truthfulness score, is held together with the generated output. For example, the generative AI processing generates, as generated outputs, news content in a news program and AI anchors that report in a mass media industry, and generates AI personalities and AI actors and the like in an entertainment industry, but generated outputs are not particularly limited. Here, the “degree indicating how much a generated output by the generative AI is based on a fact” is hereinafter defined as “truthfulness score”. The embodiment holds a state in which the truthfulness score can be confirmed. By this, for example, by notifying a user of which part of a news moving image in which an AI anchor is employed is based on a fact, the present embodiment can achieve a situation where the user can feel secure to view the news moving image in which the AI anchor is employed. A case where the information processing apparatus according to the first embodiment is applied in such a situation will be described.

### Usage Pattern

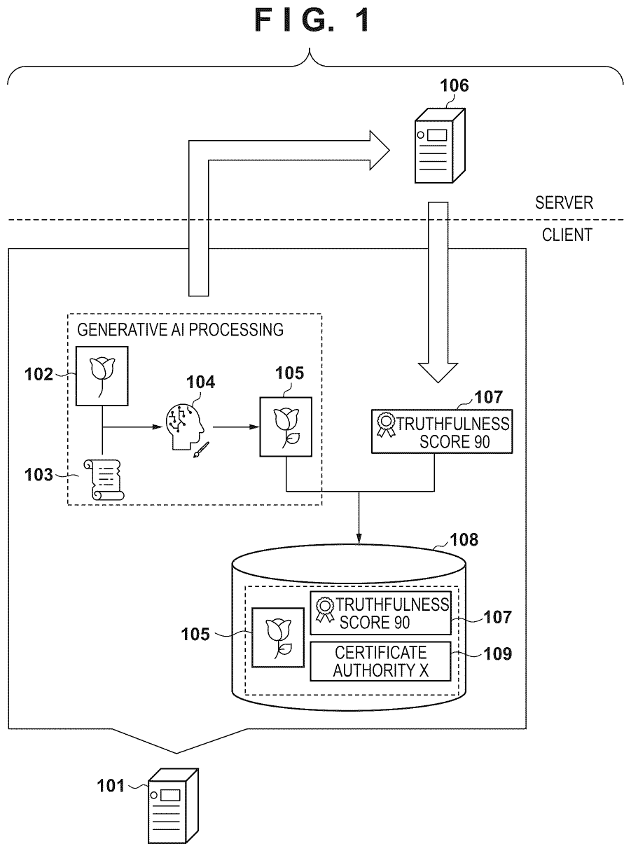

FIG. 1 is a conceptual view of the generative AI system according to the first embodiment. As illustrated in FIG. 1, the generative AI system according to the first embodiment includes a client 101 and an authentication server 106.

In the generative AI system according to the first embodiment, the client 101 generates an image as a generated output by the generative AI processing, and transmits, to the external authentication server 106, information regarding generative AI processing including the generated output and truthfulness score of the generated output. The client 101 obtains the truthfulness score (hereinafter, also called authenticated truthfulness score) authenticated by the authentication server 106, and holds a generated output 105, which is a generated image, authenticated truthfulness score 107, which is a result of authentication of truthfulness score, and identification information 109 indicating the authentication server 106 having authenticated the truthfulness score in association with one another. The authenticated truthfulness score is an example of authentication information. Hereinafter, the processing in the present embodiment will be specifically described.

The client 101 inputs an input image 102, which is an image to be a basis of generation, and a generation parameter 103 to a generation model 104 to acquire the generated output 105. Next, the client 101 requests the authentication server 106 for calculation of the truthfulness score, which is an evaluation score of the generated output 105, and authentication for the calculation result, together with information regarding the generative AI processing such as the input image 102 and the generated output 105.

The authentication server 106 receives the information and the request transmitted from the client 101, and authenticates the truthfulness score of the generated output 105 based on the information regarding the generative AI processing. In a case where the truthfulness score satisfies a predetermined authentication criterion, the authentication server 106 transmits the authenticated truthfulness score 107 to the client 101. The client 101 holds, in a database 108, the generated output 105, the authenticated truthfulness score 107 having been received, and the identification information 109 indicating the authentication server 106 associated with one another.

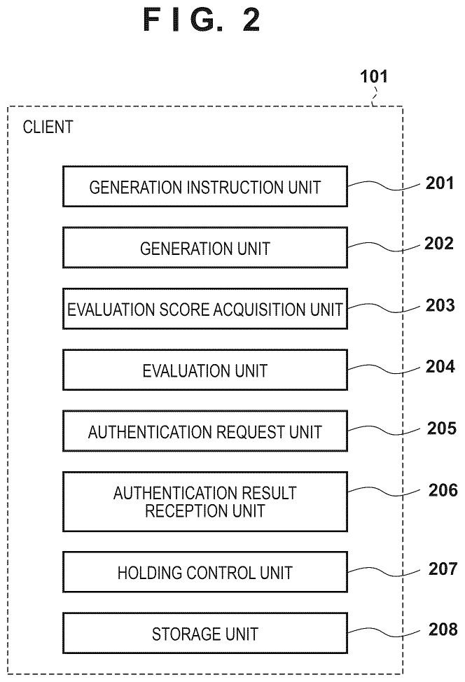

FIG. 2 is a block diagram illustrating the module configuration of the client 101 according to the first embodiment. The client 101 includes a generation instruction unit 201, a generation unit 202, an evaluation score acquisition unit 203, an evaluation unit 204, an authentication request unit 205, an authentication result reception unit 206, a holding control unit 207, and a storage unit 208.

The generation instruction unit 201 issues a generation instruction to the generation unit 202 based on information including the input image 102, the generation parameter 103, and the generation model 104.

In response to the generation instruction from the generation instruction unit 201, the generation unit 202 inputs, to the generation model 104, the input image 102 that is a processing target and the generation parameter 103 to execute the generative AI processing, and generates and outputs the generated output 105.

The evaluation score acquisition unit 203 instructs the evaluation unit 204 for calculation of the truthfulness score. The evaluation score acquisition unit 203 acquires the truthfulness score for the generated output 105 from the evaluation unit 204.

The evaluation unit 204 calculates the truthfulness score based on the information regarding the generative AI processing. For example, the evaluation unit 204 compares the input image 102 and the generated output 105 in units of pixels to calculate a difference, and calculates the truthfulness score based on a ratio of the number of pixels having a difference with respect to the number of pixels of all pixels, or the like.

The authentication request unit 205 transmits an authentication request to the authentication server 106 in order to authenticate the truthfulness score calculated by the evaluation unit 204. At this time, the authentication request unit 205 transmits, to the authentication server 106, predetermined information necessary for authentication in addition to the truthfulness score. The predetermined information is, for example, at least any of information regarding the generative AI processing, an ID indicating the client, and the like.

The authentication result reception unit 206 is an example of an acquisition means, and receives the authenticated truthfulness score 107 transmitted from the authentication server 106. The authenticated truthfulness score 107 is a result of authentication of the truthfulness score of the generated output.

The holding control unit 207 controls the storage unit 208 so as to hold the generated output 105, the authenticated truthfulness score 107, and the identification information 109 indicating the authentication server 106 in association with one another.

Under the control of the holding control unit 207, the storage unit 208 holds, in the database 108, the generated output 105, the authenticated truthfulness score 107, and the identification information 109 indicating the authentication server 106 in association with one another.

Note that means for holding the generated output 105, the authenticated truthfulness score 107, and the identification information 109 indicating the authentication server 106 in association with one another is not limited to that of the present embodiment. For example, the authenticated truthfulness score 107 and the identification information 109 indicating the authentication server 106 may be embedded in the metadata of the generated output 105. In such a case, the other two pieces of information can be confirmed with one file of the generated output 105, and therefore the reliability of the evaluation score can be indicated also in a case where the generated output 105 is shared with a user who cannot access the database 108.

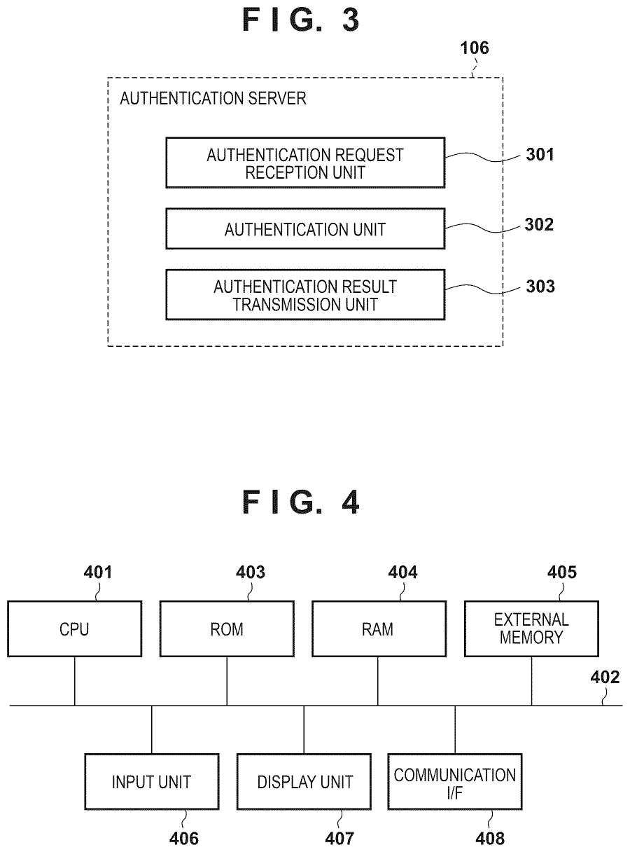

FIG. 3 is a block diagram illustrating the module configuration of the authentication server 106 according to the first embodiment. The authentication server 106 includes an authentication request reception unit 301, an authentication unit 302, and an authentication result transmission unit 303.

The authentication request reception unit 301 receives an authentication request and predetermined information transmitted from the authentication request unit 205.

The authentication unit 302 verifies validity of the truthfulness score received based on the predetermined information received by the authentication request reception unit 301, and creates an authentication result based on the verification result. A detailed processing procedure of the authentication unit 302 will be described later.

The authentication result transmission unit 303 transmits the authentication result created by the authentication unit 302 to the client 101.

### Hardware Configuration

FIG. 4 is a block diagram illustrating the hardware configuration of the information processing apparatus according to the embodiment. In the present embodiment, both the client 101 and the authentication server 106 may be an information processing apparatus having these pieces of hardware. The information processing apparatus is, for example, a computer. The information processing apparatus includes a CPU 401, a bus 402, a ROM 403, a RAM 404, an external memory 405, an input unit 406, a display unit 407, and a communication I/F 408.

The CPU 401 controls various types of devices connected to the bus 402 and executes information processing. CPU is an abbreviation for central processing unit, and the CPU 401 is a type of processor.

The information processing apparatus may include other processors such as a micro processing unit (MPU), a graphics processing unit (GPU), a neural processing unit (NPU), and a quantum processing unit (QPU), in place of the CPU 401 or in addition to the CPU 401. One or a plurality of processors including the CPU 401 read a computer program (also called a program) stored in the ROM 403 or the external memory 405, and deploys the computer program into the RAM 404 and executes the computer program, thereby implementing some or all of the modules of the information processing apparatuses of the client 101 and the authentication server 106 illustrated in FIGS. 2 and 3. The information processing apparatus may include a plurality of processors of the same type, and each of the processors may implement a different function.

Some or all of the modules of the information processing apparatuses of the client and the authentication server may be implemented by one or a plurality of circuits such as an application specific integrated circuit (ASIC) and a programmable logic device (PLD) including a field programmable gate array (FPGA).

The ROM 403 stores a program of a basic input output system (BIOS) and a boot program. ROM is an abbreviation for read only memory. The ROM 403 may be a nonvolatile memory.

The RAM 404 is used as a main storage apparatus of the CPU 401. RAM is an abbreviation for random access memory, and the RAM 404 is a memory that enables high speed reading and writing. The RAM 404 functions as a working area when the CPU 401 executes a program.

The external memory 405 stores a program to be processed by the information processing apparatus. The external memory 405 may be a nonvolatile storage apparatus such as a hard disk drive (HDD) and a solid state drive (SSD).

The input unit 406 performs processing of receiving an input such as an instruction and information from the user and outputting the input to the CPU 401. The input unit 406 may be a keyboard, a mouse, a touch pad, a touch panel, or the like.

The display unit 407 outputs a calculation result of the information processing apparatus to a display apparatus in accordance with an instruction from the CPU 401. Note that the display apparatus may be a liquid crystal display apparatus, a projector, an LED indicator, or the like, and may be of any type. LED is an abbreviation for light emitting diode.

The bus 402 connects the CPU 401, the RAM 404, the ROM 403, the external memory 405, the input unit 406, the display unit 407, and the communication I/F 408 with one another in a communication-enabling manner.

The communication I/F 408 is an interface that communicates with another information processing apparatus, and is connected to a network. In the present embodiment, the client 101 and the authentication server 106 are connected in a mutually communication-enabling manner via a network by the communication I/F 408.

### Sequence of Processing

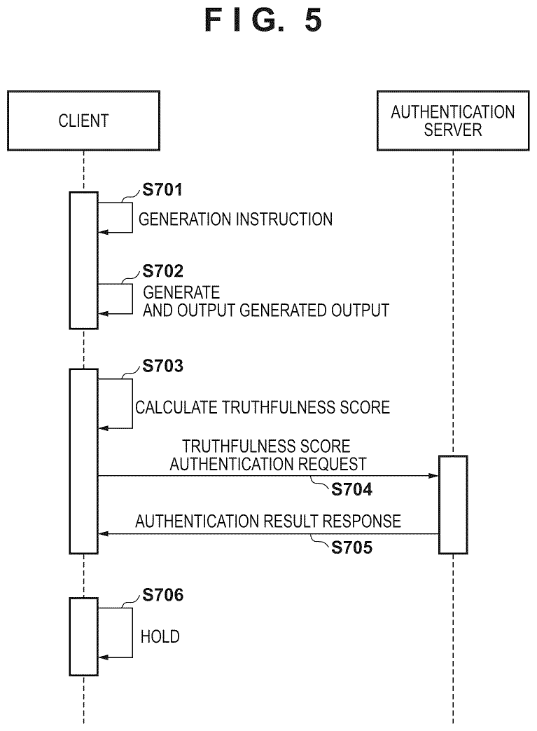

FIG. 5 is a sequence diagram of the generative AI system according to the first embodiment. Specifically, FIG. 5 illustrates a processing sequence between the client 101 and the authentication server 106 according to the first embodiment.

In step S701, the generation instruction unit 201 of the client 101 issues a generation instruction to the generation unit 202 based on information including the input image 102, the generation parameter 103, and the generation model 104.

In step S702, in response to the instruction from the generation instruction unit 201, the generation unit 202 generates and outputs the generated output 105.

In step S703, the evaluation unit 204 calculates truthfulness score, which is an evaluation score for the calculated generated output. The evaluation score acquisition unit 203 acquires the truthfulness score for the generated output calculated by the evaluation unit 204.

In step S704, the authentication request unit 205 transmits an authentication request to the authentication server 106 in order to authenticate the truthfulness score before authentication having been acquired. At this time, the authentication request unit 205 may transmit, to the authentication server 106, predetermined information necessary for authentication, in addition to the truthfulness score before authentication. The predetermined information includes, for example, the input image 102 and the generated output 105.

When the authentication request reception unit 301 receives the authentication request, the authentication server 106 verifies the validity of the truthfulness score of the generated output acquired by the authentication unit 302, and generates an authentication result including the authenticated truthfulness score in accordance with the verification result. Note that in a case of rejecting the authentication, the authentication unit 302 may include the rejection into the authentication result.

In step S705, the authentication result transmission unit 303 transmits, to the client 101, a response including the authentication result created by the authentication unit 302.

In the client 101, the authentication result reception unit 206 receives, as a response, the authentication result including the authenticated truthfulness score. The authentication result reception unit 206 outputs the acquired response to the holding control unit 207.

In step S706, the holding control unit 207 controls the storage unit 208 so as to hold the generated output 105, the authenticated truthfulness score 107 having been received, and the identification information 109 indicating the authentication server 106 in association with one another. By this, the storage unit 208 holds the generated output 105, the authenticated truthfulness score 107 having been received, and the identification information 109 indicating the authentication server 106 in association with one another.

### Detailed Description of Authentication Means

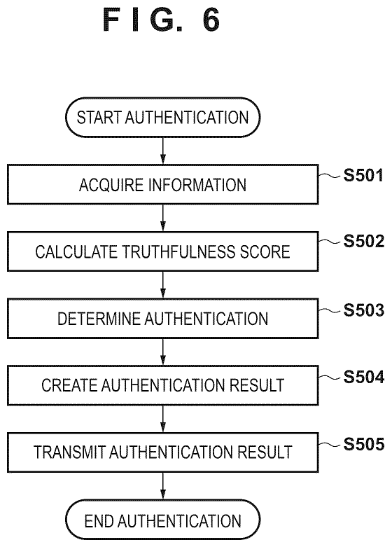

FIG. 6 is a flowchart showing the processing procedure of the authentication server 106 according to the first embodiment.

In step S501, the authentication request reception unit 301 acquires information used for authentication from the received predetermined information. For example, the authentication request reception unit 301 acquires the input image 102, the generated output 105, and the truthfulness score before authentication.

In step S502, the authentication unit 302 calculates the truthfulness score for comparison with the received truthfulness score based on the information acquired in step S501. For example, the authentication unit 302 compares the input image 102 and the generated output 105 in units of pixels to calculate the truthfulness score based on a ratio of the number of pixels having a difference with respect to the number of pixels of all pixels, or the like.

In step S503, the authentication unit 302 determines whether or not to authenticate the truthfulness score before authentication having been received based on the verification result obtained in step S502. For example, the authentication unit 302 compares the truthfulness score calculated in step S502 with the truthfulness score before authentication having been received, and permits authentication in a case where the absolute value of the difference between both the truthfulness scores is a predetermined threshold or less (or less than the threshold) and rejects the authentication otherwise.

In step S504, the authentication unit 302 creates an authentication result based on the determination result obtained in step S503. For example, in a case of permitting the authentication in step S503, the authentication unit 302 sets, as an authentication result, the truthfulness score received in step S501 as the authenticated truthfulness score 107 together with a message notifying that the authentication is permitted. In a case of rejecting the authentication in step S503, the authentication unit 302 sets, as an authentication result, the truthfulness score calculated in step S502 together with a message notifying that the authentication is rejected.

In step S505, the authentication result transmission unit 303 transmits, to the client 101, the authentication result including the authenticated truthfulness score generated by the authentication unit 302.

By performing the above steps, the authentication processing by the authentication unit 302 ends.

### Effects

In the first embodiment described above, it is possible to improve the reliability of the truthfulness score of the generated output by holding the authenticated truthfulness score acquired from the external authentication server 106 in association with the generated output. Furthermore, in the first embodiment, by notifying the user of the authenticated truthfulness score, the user can feel secure to view the generated output.

In the first embodiment, the generated output generated by the generative AI processing, the truthfulness score that is the evaluation score thereof, and the identification information 109 of the authentication server 106 having authenticated the truthfulness score are held in association with one another. This enables the first embodiment to indicate the reliability of the evaluation score of the generated output. According to the configuration of the first embodiment, the user can calculate the truthfulness score on the client side, and can request authentication from the authentication server only in a case where authentication is necessary. This configuration can perform the authentication processing only in a case of necessity while easily confirming the truthfulness score of the generated output.

### Modification 1-1: Authentication Server Evaluates

In the first embodiment, the client 101 includes the evaluation unit 204. However, the authentication server 106 may include the evaluation unit 204 instead of the client 101.

In this case, the authentication result transmission unit 303 of the authentication server 106 sets, as an authenticated truthfulness score, the evaluation score calculated by the evaluation unit 204 of the authentication server 106, holds the authenticated truthfulness score in the storage unit such as a storage, and transmits the authenticated truthfulness score as an authentication result including the authenticated truthfulness score. Next, the evaluation score acquisition unit 203 acquires the authenticated truthfulness score that is an evaluation score received by the authentication result reception unit 206 of the client 101. Note that in this case, the processing of step S502 and step S503 can be omitted. This is because the evaluation score is calculated by the authentication server 106 itself and therefore verification is unnecessary.

By this, calculation and authentication of the evaluation score are completed in the authentication server 106, and therefore the reliability of the authentication result can be enhanced, and the evaluation score can be calculated by a method unique to the authentication server 106. This is an effective embodiment for an authentication server in which it is desired to keep the calculation method of the evaluation score and the authentication criterion confidential.

### Modification 1-2: Generation Server Executes Generation, Evaluation, and Authentication Request

In the first embodiment, the client 101 includes the generation unit 202. However, a third information processing apparatus as a generation server may include the generation unit 202 in place of the client 101. Furthermore, the generation server may include the evaluation unit 204, the authentication request unit 205, and the authentication result reception unit 206. At this time, the generative AI system according to the present embodiment includes the client 101, the generation server, and the authentication server 106.

In this case, the client 101 transmits a generation instruction to the generation server. When the generation server receives the generation instruction, the generation unit 202 generates and outputs the generated output 105. Next, the generation server calculates an evaluation score based on the evaluation unit 204, and transmits an authentication request to the authentication server 106 based on the authentication request unit 205. The authentication server creates and transmits, to the generation server, an authentication result similarly to the first embodiment. The generation server transmits, to the client 101, the generated output 105 and the authentication result received by the authentication result reception unit 206.

By this, processing related to generation and evaluation can be executed on the generation server, and therefore the client 101 does not need to have a generation means and an evaluation means. This is an effective embodiment in a case where the client 101 does not have enough resources to calculate the generative AI processing. This is an effective embodiment also in a case where a company or the like desires to keep the details of the generation model confidential when providing the generative AI as a service.

### Modification 1-3: Authentication Server Issues Certificate of Evaluation Score

In the first embodiment, the authentication unit 302 creates an authentication result including an evaluation score and a message notifying of the authentication result. However, the authentication unit 302 may set an authentication result in which additional processing is performed on the evaluation score and the message notifying of the authentication result. For example, the authentication unit 302 may use, as an authentication result, a digital certificate of the evaluation score having, as content, the evaluation score and the message notifying of the authentication result.

In this case, the authentication server 106 may create in advance and store a private key and a public key used for the digital signature of the digital certificate of the evaluation score. The authentication server 106 may publish the public key in a form available to a third party via an appropriate medium such as the Internet. Next, the authentication unit 302 creates data including the evaluation score and the message notifying of the authentication result, performs digital signature using the private key, and creates and sets, as an authentication result, a digital certificate of the evaluation score based on the data notifying of the authentication result and the digital signature.

This clarifies authenticator information for the evaluation score, and allows a third party to detect falsification on the authenticator information, the authentication result, and the like, and therefore, the authentication server 106 can further improve the reliability of the evaluation score for the generated output of the generative AI. This method is effective when publishing the generated output to the general public on the Internet or the like.

Note that the authentication server 106 may publish a digital certificate of the public key based on a known public key infrastructure (PKI) mechanism. In this case, if the authentication server 106 is a root certificate authority, the digital certificate of the public key may be signed with the private key created by the authentication server 106. On the other hand, in a case where the authentication server 106 is not a root certificate authority, a certificate authority higher than the authentication server 106 may perform the signature.

### Modification 1-4: Behavior at Time of Falsification Detection

In the first embodiment, an embodiment in a case where normal generative AI processing is performed by the client 101 has been described. However, it is conceivable that a client of a malicious user transmits false information to the authentication server 106 to obtain unauthorized authentication. Therefore, the first embodiment may have a mechanism for falsification prevention.

In this case, the client 101 records, in a log, information on input and output in a non-rewritable format at each timing of performing generation processing and evaluation processing, and also transmits this log at the time of the authentication request. At this time, in step S502, the authentication unit 302 performs verification also using the log transmitted by the client 101. The authentication unit 302 may reject the authentication in a case where information on the log is not included at the time of receiving the authentication request. In addition, the holding control unit 207 may invalidate the storage unit 208 in a case where the authentication is rejected.

This enables the generative AI system to prevent falsification of the authentication result, and therefore the reliability of the evaluation score for the generated output of the generative AI can be further improved.

### Modification 1-5: Variation of Calculation Method of Evaluation Score

In the first embodiment, the evaluation unit 204 uses a difference in units of pixels for calculation of the truthfulness score. However, if the truthfulness score is information indicating the degree of alteration from an input image by the generative AI, the evaluation unit 204 may calculate the truthfulness score by any calculation method.

For example, the evaluation unit 204 may calculate the truthfulness score based on similarity between the input image 102 and the generated output 105. Specifically, the evaluation unit 204 may calculate the truthfulness score based on similarity between edge images of the input image 102 and the generated output 105, or similarity in further consideration of a color difference. The evaluation unit 204 may calculate the truthfulness score based on an image quality evaluation index of at least any of a mean square error (MSE), a PSNR, and an SSIM. In a case where information is added to at least any of input data used for the generative AI processing, a generation model used for the generative AI processing, a prompt used for the generative AI processing, learning data of the generation model used for the generative AI processing, and the like, the evaluation unit 204 may calculate the truthfulness score using this added information. In a case where a history of the input data used for the generative AI processing is included in the additional information, the evaluation unit 204 may calculate the truthfulness score using the additional information. For example, in a case where the information indicating the history of the input data includes at least any of the information on the alteration amount and the number of times of alteration of the input data by the processing by the past generative AI, the presence or absence and the intensity of noise added to the input data, and the presence or absence of a digital watermark, the evaluation unit 204 may calculate the truthfulness score based on at least any of these pieces of information. In addition, in a case where there is information that associates at least any of the generation model and the prompt with the evaluation score of the generated output, the evaluation unit 204 may calculate the truthfulness score based on this information.

This enables the evaluation unit 204 to calculate the truthfulness score by various types of methods, and therefore it is possible to record evaluation results from various viewpoints for the generated outputs. This enables the generative AI system to further improve the reliability of the evaluation score for the generated output of the generative AI.

### Second Embodiment: Generation of Generated Output by Authenticated Application

In the first embodiment, the authentication server authenticates the evaluation score of the generated output based on information regarding the generative AI processing by the client. In the present embodiment, the authentication server authenticates and publishes, as an authenticated application, an application for performing the generative AI processing. The client performs the generative AI processing using this authenticated application. An information processing apparatus according to the second embodiment in this configuration will be described. In the present embodiment, it can be said that the authenticated application is associated with authentication information indicative of having been authenticated, and it can also be said that the authenticated application is an example of authentication information.

### Usage Pattern

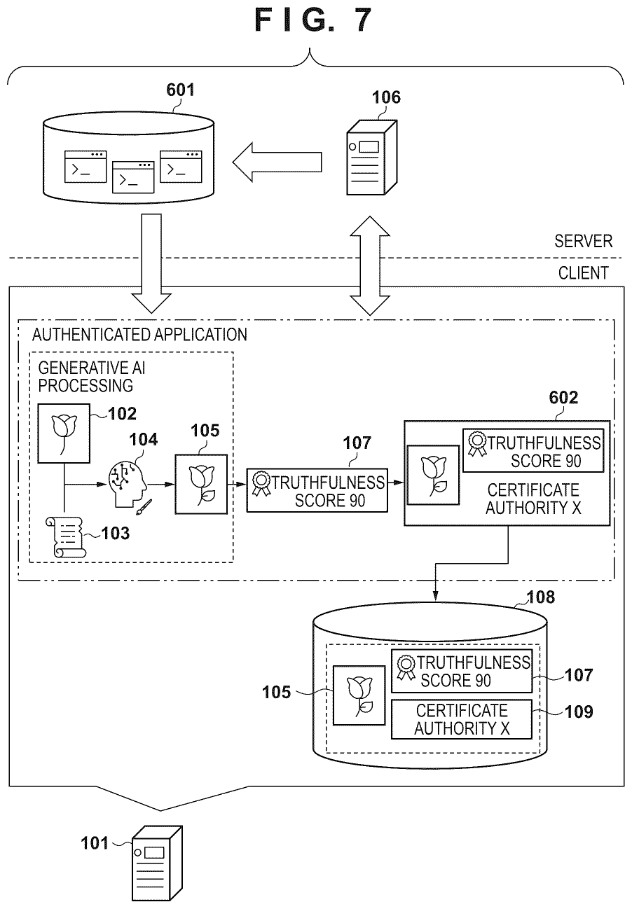

FIG. 7 is a conceptual view of the generative AI system according to the second embodiment.

FIG. 7 illustrates a situation where the authentication server 106 publishes an authenticated generative AI application (hereinafter, also called an authenticated application), and the client 101 performs the generative AI processing using the authenticated application. Hereinafter, the generative AI system of the second embodiment will be specifically described.

The authentication server 106 stores a generative AI application satisfying a predetermined authentication criterion into an application database 601 as an authenticated application and publishes the application. The client 101 acquires an arbitrary authenticated application from the application database 601 and starts the application. The client 101 executes processing from generation to authentication on the application, and holds, in the database 108, a product 602 that is obtained.

### Configuration

The generative AI system according to the present embodiment includes the client 101, the authentication server 106, and an authenticated application. This is a configuration in which not the client 101 but the authenticated application includes the generation unit and the evaluation unit as compared with the generative AI system according to the first embodiment.

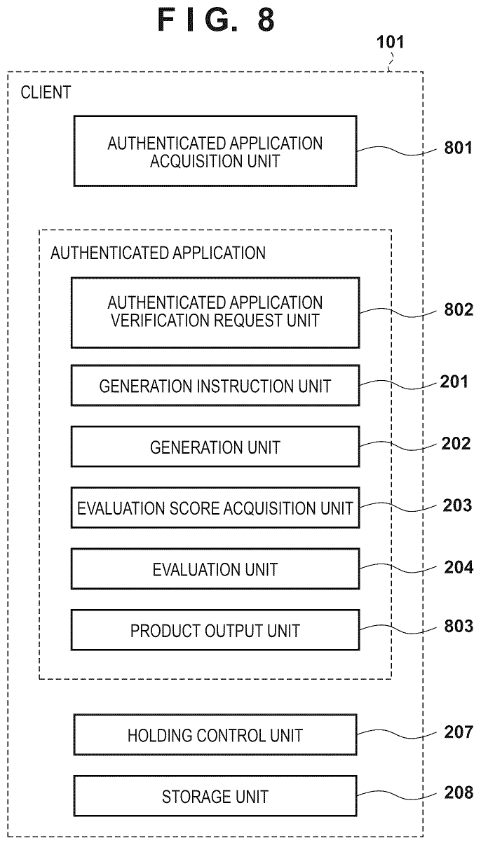

FIG. 8 is a block diagram illustrating the module configuration of the client 101 according to the second embodiment. The client 101 includes an authenticated application acquisition unit 801, an authenticated application verification request unit 802, the generation instruction unit 201, the generation unit 202, the evaluation score acquisition unit 203, the evaluation unit 204, a product output unit 803, the holding control unit 207, and the storage unit 208. Note that the authenticated application verification request unit 802, the generation instruction unit 201, the generation unit 202, the evaluation score acquisition unit 203, the evaluation unit 204, and the product output unit 803 may have a configuration of the authenticated application.

The authenticated application acquisition unit 801 acquires a list of authenticated applications from the application database 601. The authenticated application acquisition unit 801 downloads an arbitrary authenticated application from the list to the client 101 based on an instruction from the user or the like. The authenticated application acquisition unit 801 starts the acquired authenticated application.

The authenticated application verification request unit 802 requests the authentication server 106 to verify whether the authenticated application started by the authenticated application acquisition unit 801 has not been illegally altered from the time of authentication of the authentication server 106. At this time, the authenticated application verification request unit 802 may also transmit predetermined information necessary for verification to the authentication server 106. The predetermined information may be, for example, at least any of an application and a hash value of a library.

The product output unit 803 outputs the generated output 105, the authenticated truthfulness score 107, and identification information 109 indicating the authentication server 106.

The other modules are similar to those of the first embodiment. However, in the present embodiment, since both generation and evaluation are performed on the authenticated application that has undergone verification, the truthfulness score calculated by the evaluation unit 204 can be treated as the authenticated truthfulness score 107 from the beginning.

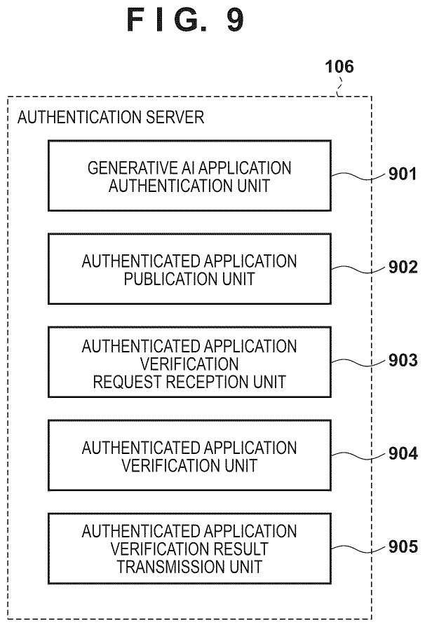

FIG. 9 is a block diagram illustrating the module configuration of the authentication server 106 according to the second embodiment. The authentication server 106 includes a generative AI application authentication unit 901, an authenticated application publication unit 902, an authenticated application verification request reception unit 903, an authenticated application verification unit 904, and an authenticated application verification result transmission unit 905.

The generative AI application authentication unit 901 confirms whether the generative AI application satisfies a predetermined authentication criterion, and sets an application satisfying the criterion as an authenticated application. For example, the generative AI application authentication unit 901 authenticates a generative AI application as an authenticated application by confirming whether the evaluation score calculation method of a generated output satisfies a predetermined condition defined by the authentication server 106, whether processing on the application is protected so as not to be falsified, and the like. The generative AI application authentication unit 901 stores the authenticated application having been authenticated into the application database 601.

The authenticated application publication unit 902 publishes the authenticated application in a form available to a predetermined client. For example, the authenticated application publication unit 902 may publish the authenticated application in a format that can be downloaded to a website on the Internet so as to be available to the general public, or may publish the authenticated application as an installation disk so as to be available to only a purchaser.

The authenticated application verification request reception unit 903 receives the verification request and the predetermined information transmitted from the authenticated application verification request unit 802.

The authenticated application verification unit 904 verifies validity of the application based on the predetermined information received by the authenticated application verification request reception unit 903, and creates a verification result based on the verification. Note that in a case where additional information is required during the validity verification of the application, the authenticated application verification unit 904 may instruct the client 101 to transmit the additional information.

The authenticated application verification result transmission unit 905 transmits the verification result created by the authenticated application verification unit 904 to the client 101.

### Sequence of Processing

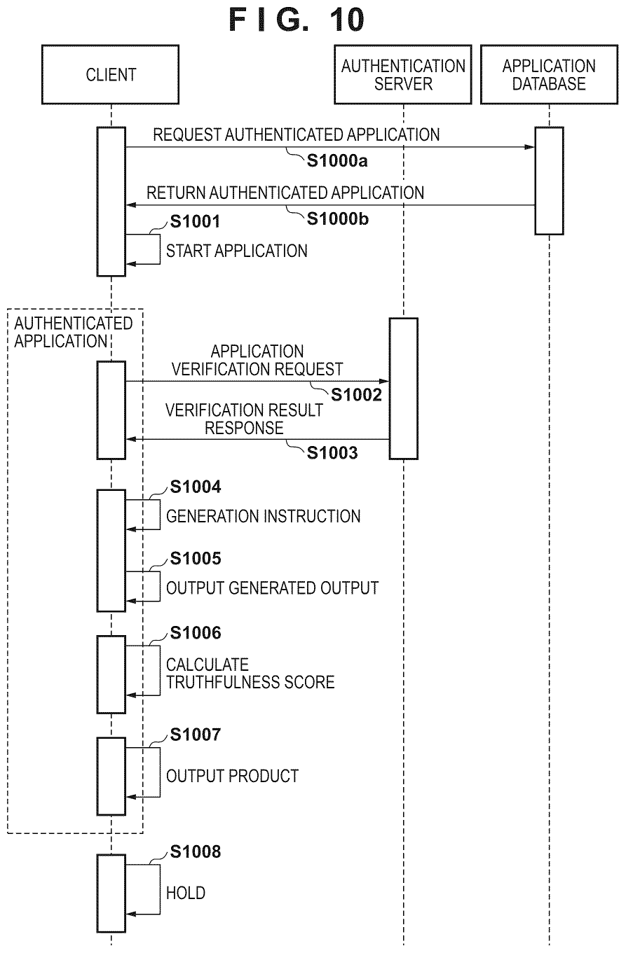

FIG. 10 is a sequence diagram of the generative AI system according to the second embodiment. Specifically, FIG. 10 is a diagram illustrating a processing sequence among the client 101, the authentication server 106, the application database, and 601 according to the second embodiment.

In step S1000a, the authenticated application acquisition unit 801 of the client 101 requests the authenticated application from the application database 601.

In step S1000b, the application database 601 transmits a response including the authenticated application to the client 101 in response to a request from the client 101.

In step S1001, the authenticated application acquisition unit 801 starts the downloaded authenticated application.

In step S1002, the authenticated application verification request unit 802 transmits an application verification request to the authentication server 106.

In the authentication server 106, the authenticated application verification request reception unit 903 receives the verification request and outputs the verification request to the authenticated application verification unit 904. Based on the verification request, the authenticated application verification unit 904 verifies the authenticated application and generates a verification result.

In step S1003, the authenticated application verification result transmission unit 905 transmits the verification result to the client 101 as a response to the verification request.

In step S1004, the generation instruction unit 201 of the client 101 issues a generation instruction to the generation unit 202 based on information including the input image 102, the generation parameter 103, and the generation model 104.

In step S1005, in response to the generation instruction from the generation instruction unit 201, the generation unit 202 generates and outputs the generated output 105.

In step S1006, the evaluation unit 204 calculates truthfulness score, which is an evaluation score for the generated output. Note that in the present embodiment, since both generation and evaluation are performed on the authenticated application that has undergone verification, the truthfulness score calculated by the evaluation unit 204 can be treated as the authenticated truthfulness score 107 from the beginning. The evaluation score acquisition unit 203 acquires, as an authentication result, the truthfulness score calculated by the evaluation unit 204.

In step S1007, the product output unit 803 outputs the generated output 105, the authenticated truthfulness score 107, and identification information 109 indicating the authentication server 106.

In step S1008, the holding control unit 207 controls the storage unit 208 so as to hold the generated output 105, the authenticated truthfulness score 107, and the identification information 109 indicating the authentication server 106 in association with one another.

### Effects

According to the second embodiment described above, the client 101 performs, on the authenticated application authenticated by the authentication server 106, the procedure from the generative AI processing to evaluation of the generated output and authentication of the evaluation score. This enables the second embodiment to prevent falsification in the process of the procedure, and to record, as being more reliable, the reliability of the authenticated truthfulness score, which is an evaluation score for the generated output. Since the second embodiment verifies the authenticated application, it is possible to further improve the reliability of the truthfulness score of the generated output.

According to the configuration of the second embodiment, the user can perform generation to authentication only by preparing an authenticated application. This configuration enables the second embodiment to aggregate tools for the generative AI processing, and therefore it is possible to facilitate creation of an environment for generation.

### Modification 2-1: Additionally Perform Verification and Authentication

The authenticated application that executes the generative AI processing according to the second embodiment is protected so that the processing from generation to authentication on the application cannot be falsified from the outside. Therefore, in the second embodiment, verification is performed once at the time of start of the authenticated application, and thereafter, verification of an application and authentication of an evaluation score are not performed. However, the second embodiment may additionally perform at least any of application verification and authentication of an evaluation score. For example, the second embodiment may verify an application also before and after generation, and may authenticate an evaluation score similarly to the first embodiment. In this case, the second embodiment can more effectively prevent unauthorized alteration of an application, falsification of an authentication result, and the like.

### Modification 2-2: Omit Verification

In the second embodiment described above, an example in which the authentication server 106 verifies the authenticated application has been described, but in the present modification, the truthfulness score of a generated output generated by an unverified authenticated application may be held as authenticated truthfulness score.

### Third Embodiment: Generation by Authenticated Model, Evaluation Score=AI Learning Data Suitability

In the present embodiment, the authentication server 106 authenticates and publishes, as an authenticated model, a generation model to be used for the generative AI processing. The client 101 performs the generative AI processing using the authenticated model. In the present embodiment, it can be said that the authenticated model is associated with authentication information that is information indicative of having been authenticated, and is an example of authentication information. The third embodiment in this configuration will be described.

### Usage Pattern

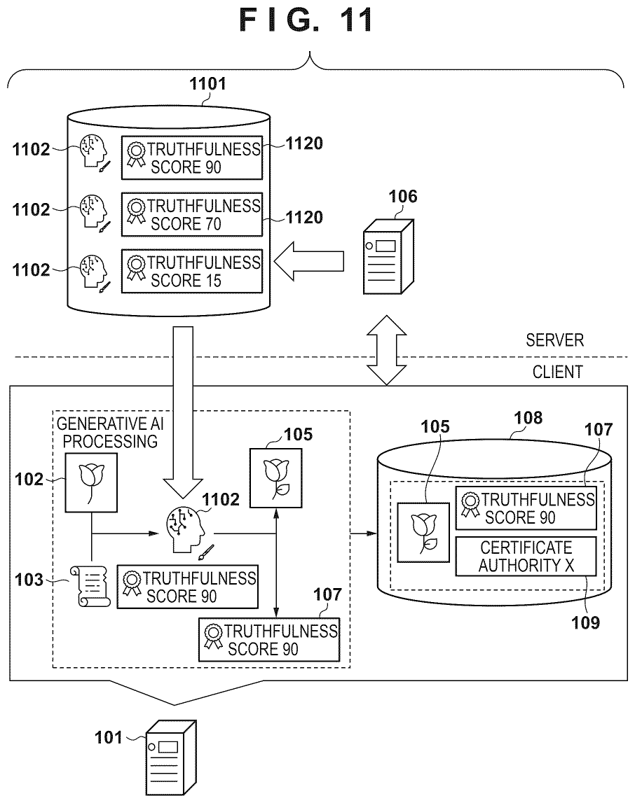

FIG. 11 is a conceptual view of the generative AI system according to the third embodiment.

FIG. 11 illustrates a situation where the authentication server 106 publishes an authenticated generation model (hereinafter, also called an authenticated model), and the client 101 performs the generative AI processing using the authenticated model. Hereinafter, the generative AI system of the third embodiment will be specifically described.

The authentication server 106 publishes, into a model database 1101, a generation model satisfying a predetermined authentication criterion as an authenticated model 1102. The client 101 acquires an arbitrary authenticated model 1102 together with an authenticated truthfulness score 1120 from the model database 1101. The authenticated truthfulness score 1120 associated with the authenticated model 1102 is an example of a model truthfulness score. In the generative AI processing, the client 101 performs generation using the authenticated model 1102, and holds, in the database 108, the obtained generated output 105, the authenticated truthfulness score 107, and the identification information 109 indicating the authentication server 106 in association with one another.

Note that in the model database 1101, each authenticated model 1102 is associated with the authenticated truthfulness score 1120 that is the authentication result thereof. For example, the authenticated model 1102 associated with the authenticated truthfulness score 1120 indicating a high value (e.g., “90”) means that the input image 102 is rarely altered. The authenticated model 1102 associated with the authenticated truthfulness score 1120 that is high in this manner is a model that handles processing with a relatively small degree of alteration to the input image 102, such as noise reduction or super resolution. On the other hand, the authenticated model 1102 associated with the authenticated truthfulness score 1120 indicating a low value (e.g., “15”) means that the input image 102 is greatly altered, and this is a model that handles processing such as style transformation and image generation of a non-real person. The authenticated model 1102 may output the associated authenticated truthfulness score 1120 together with the output of the generated output.

### Configuration

The generative AI system according to the present embodiment includes the client 101 and the authentication server 106.

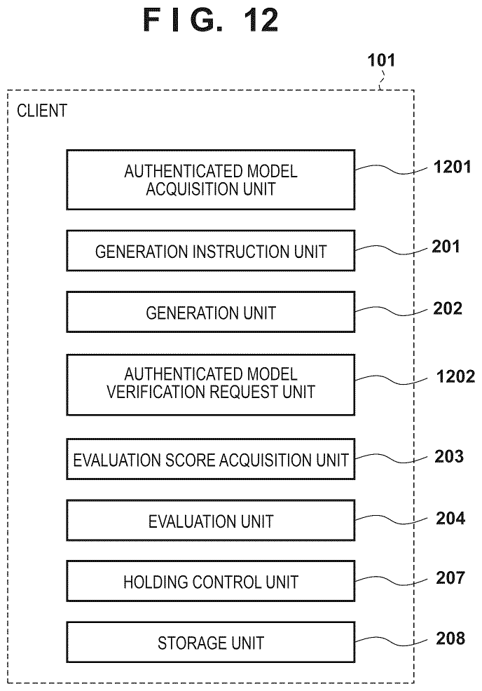

FIG. 12 is a block diagram illustrating the module configuration of the client 101 according to the third embodiment. The client 101 includes an authenticated model acquisition unit 1201, the generation instruction unit 201, the generation unit 202, an authenticated model verification request unit 1202, the evaluation score acquisition unit 203, the evaluation unit 204, the holding control unit 207, and the storage unit 208.

The authenticated model acquisition unit 1201 acquires a list of authenticated models from the model database 1101, and downloads an arbitrary authenticated model from the list to the client 101. The authenticated model acquisition unit 1201 may download the authenticated model together with the authenticated truthfulness score 1120. The authenticated model acquisition unit 1201 starts the downloaded authenticated model.

The authenticated model verification request unit 1202 requests the authentication server 106 to verify whether the authenticated model 1102 has not been illegally altered from the time of authentication of the authentication server 106. At this time, the authenticated model verification request unit 1202 also transmits predetermined information necessary for verification to the authentication server 106. The predetermined information includes, for example, at least any of a hash value of the authenticated model 1102 and output information obtained when predetermined verification data is input to the authenticated model 1102.

The evaluation unit 204 according to the present embodiment calculates the authenticated truthfulness score 107 of the generated output 105 based on the evaluation score that is the authenticated truthfulness score 1120 associated with the authenticated model 1102. A detailed processing procedure will be described later.

The other modules are similar to those of the first embodiment.

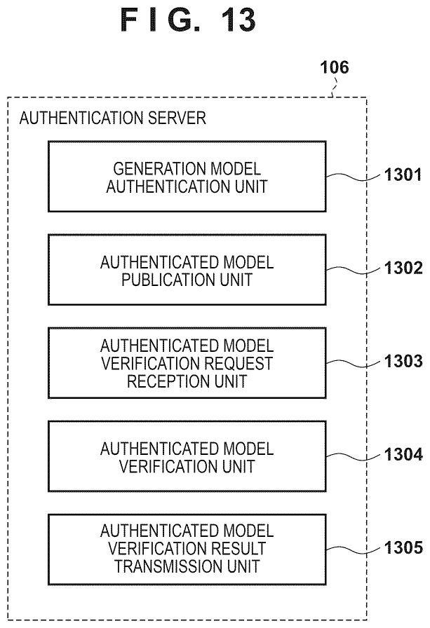

FIG. 13 is a block diagram illustrating the module configuration of the authentication server 106 according to the third embodiment. The authentication server 106 includes a generation model authentication unit 1301, an authenticated model publication unit 1302, an authenticated model verification request reception unit 1303, an authenticated model verification unit 1304, and an authenticated model verification result transmission unit 1305.

The generation model authentication unit 1301 confirms whether or not a generation model satisfies a predetermined authentication criterion, and authenticates the generation model satisfying the criterion as an authenticated model. For example, the generation model authentication unit 1301 authenticates the generation model by confirming what a feature of the generation model is, how much the output data when the authentication data is input has been altered, what the structure of the generation model is, and the like.

The authenticated model publication unit 1302 publishes the authenticated model in a form available to a predetermined client. For example, the authenticated model publication unit 1302 may publish the authenticated model in a format that can be downloaded to a website on the Internet so as to be available to the general public, or may publish the authenticated model as an installation disk so as to be available to only a purchaser.

The authenticated model verification request reception unit 1303 receives the verification request and the predetermined information transmitted from the authenticated model verification request unit 1202.

Based on the predetermined information received by the authenticated model verification request reception unit 1303, the authenticated model verification unit 1304 determines whether the authenticated model 1102 satisfies a predetermined authentication criterion defined by the authentication server 106, and creates a verification result based on the result. A detailed processing procedure of the authenticated model verification unit 1304 will be described later.

The authenticated model verification result transmission unit 1305 transmits the verification result created by the authenticated model verification unit 1304 to the client 101.

### Sequence of Processing

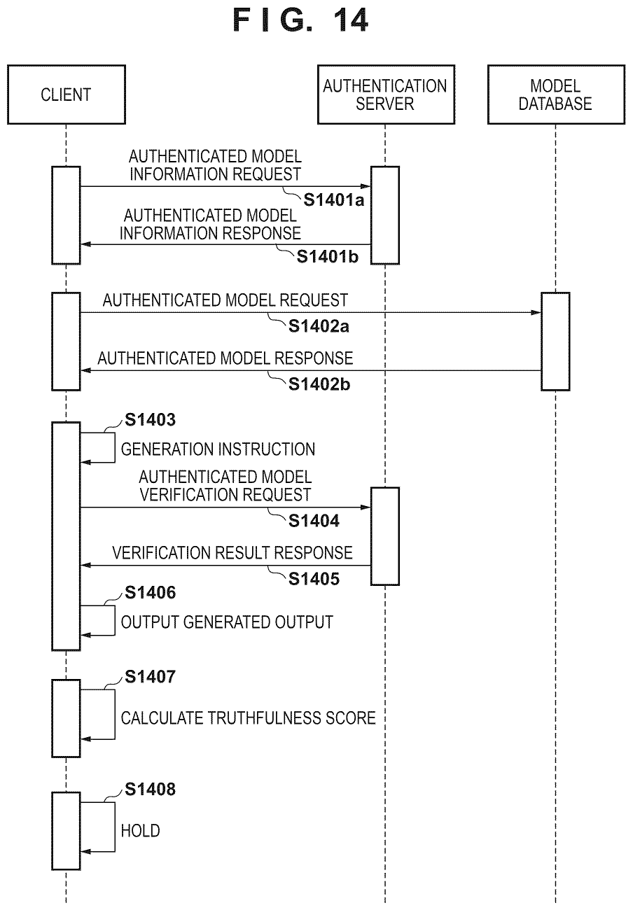

FIG. 14 is a sequence diagram of the generative AI system according to the third embodiment. Specifically, FIG. 14 is a diagram illustrating a processing sequence among the client 101, the authentication server 106, and the model database 1101 according to the third embodiment.

In step S1401a, the authenticated model acquisition unit 1201 of the client 101 requests information of the authenticated model 1102 from the authentication server 106.

In step S1401b, the authenticated model publication unit 1302 of the authentication server 106 responds with and transmits, to the client 101, information of the authenticated model to be published.

In step S1402a, the authenticated model acquisition unit 1201 transmits information of the authenticated model acquired from the authentication server 106 to the model database 1101 to request an authenticated model.

In step S1402b, the model database 1101 transmits the authenticated model 1102 corresponding to the request to the client 101 as a response. The model database 1101 may transmit the authenticated model to the client 101 together with the authenticated truthfulness score 1120. The authenticated model acquisition unit 1201 acquires, from the model database 1101, and starts the authenticated model 1102 corresponding to the request together with the authenticated truthfulness score 1120.

In step S1403, the generation instruction unit 201 issues a generation instruction to the generation unit 202 based on information including the input image 102, the generation parameter 103, and the authenticated model 1102.

In step S1404, the authenticated model verification request unit 1202 requests the authentication server 106 to verify whether the authenticated model 1102 having been acquired has not been illegally altered from the time of authentication of the authentication server 106.

In the authentication server 106, the authenticated model verification request reception unit 1303 receives and outputs, to the authenticated model verification unit 1304, the verification request. In response to the verification request, the authenticated model verification unit 1304 verifies the authenticated model and generates a verification result.

In step S1405, the authenticated model verification result transmission unit 1305 transmits the verification result created by the authenticated model verification unit 1304 to the client 101 as a response to the request.

In step S1406, in response to the instruction from the generation instruction unit 201, the generation unit 202 generates and outputs the generated output 105 by the authenticated model 1102. Note that the generation unit 202 need not generate the generated output in a case where the verification result indicates that authentication is impossible.

In step S1407, the evaluation unit 204 calculates truthfulness score, which is an evaluation score for the generated output. Note that the generated output of an evaluation target of the evaluation unit 204 is a generated output by a verified authenticated model, the truthfulness score calculated by the evaluation unit 204 may be treated as the authenticated truthfulness score 107. In other words, it can be said that the authenticated truthfulness score 1120 of the authenticated model corresponds to the authenticated truthfulness score 107 of the generated output. The evaluation score acquisition unit 203 acquires the authenticated truthfulness score 107 calculated by the evaluation unit 204.

In step S1408, the holding control unit 207 controls the storage unit 208 so as to hold the generated output 105, the authenticated truthfulness score 107, and the identification information 109 indicating the authentication server 106 in association with one another.

### Detailed Description of Evaluation Means

In the present embodiment, the authenticated model 1102 used in the generative AI processing is associated with the authenticated truthfulness score 1120. Therefore, the evaluation unit 204 according to the present embodiment calculates the authenticated truthfulness score 107 of the generated output 105 based on the authenticated truthfulness score 1120 associated with the authenticated model 1102. Specifically, since the truthfulness score 1120 associated with the authenticated model 1102 is “90”, the evaluation unit 204 calculates “90” as the authenticated truthfulness score 107 of the generated output.

### Detailed Description of Authenticated Model Verification Means

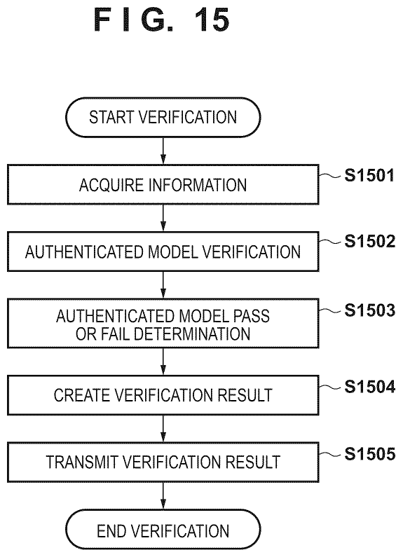

FIG. 15 is a flowchart showing the processing procedure of the authentication server 106 according to the third embodiment.

In step S1501, the authenticated model verification request reception unit 1303 acquires information to be used for verification from predetermined information having been received. The predetermined information is, for example, at least any of a hash value of the authenticated model 1102 and output information obtained when predetermined verification data is input to the authenticated model 1102.

In step S1502, the authenticated model verification unit 1304 verifies whether the authenticated model 1102 of the client 101 has not been illegally altered, based on the information acquired in step S1501. For example, the authenticated model verification unit 1304 compares the hash value of the authenticated model 1102 transmitted by the client 101 with the hash value of each model recorded in the model database 1101, and if there is a match, stores the result. Note that in a case where additional information is necessary in the middle of verifying the authenticated model 1102, the authenticated model verification unit 1304 may instruct the client 101 to transmit the additional information.

In step S1503, the authenticated model verification unit 1304 determines pass or fail of the authenticated model of the verification target. For example, the authenticated model verification unit 1304 determines whether the authenticated model 1102 of the client 101 satisfies the predetermined authentication criterion defined by the authentication server 106 based on the verification result obtained in step S1502. For example, in a case of determining that the hash values match in step S1502, the authenticated model verification unit 1304 can determine that the authenticated model 1102 of the client 101 has not been altered, and therefore may determine that the authenticated model of the verification target is passed.

In step S1504, the authenticated model verification unit 1304 creates a verification result based on the determination result obtained in step S1503. For example, in a case where it is determined to be passed in step S1503, a message notifying that the authenticated model 1102 of the client 101 satisfies the authentication criterion of the authentication server 106 is set as a verification result. In a case where it is determined to be failed in step S1503, a message notifying that the authenticated model 1102 of the client 101 does not satisfy the authentication criterion of the authentication server 106 is set as a verification result.

In step S1505, the authenticated model verification result transmission unit 1305 transmits the verification result to the client 101.

By performing the above steps, the authentication server 106 ends the verification processing.

### Effects

According to the third embodiment described above, the client 101 performs the generative AI processing using the generative AI model authenticated by the authentication server 106. This makes the client 101 easily predict the evaluation score of the generated output in advance depending on what authenticated model to select. Therefore, the client 101 enables the user to efficiently achieve the generative AI processing in a situation where there is a desire or restriction regarding the evaluation score of the generated output in advance.

### Modification 3-1: Verification by Input/Output of Authenticated Model

In the third embodiment, an example in which a hash value is used for verification of the authenticated model 1102 in the authenticated model verification unit 1304 has been described. However, the method by which the authenticated model verification unit 1304 verifies the authenticated model 1102 is not limited to the method described in the present embodiment as long as it is possible to confirm whether the authenticated model 1102 satisfies the predetermined authentication criteria defined by the authentication server 106.

For example, the authenticated model verification unit 1304 may acquire a model having the same name as the authenticated model 1102 from the model database 1101, and input, to the model, verification data, generation parameters, and the like. Then, the authenticated model verification unit 1304 may compare the obtained output with the information transmitted by the client 101 and create a verification result based on the result.

This enables the authenticated model verification unit 1304 to perform verification based on internal processing of the authenticated model 1102, and therefore it is easy to give a range to the authentication criterion of the model as compared with a case where comparison is performed by matching of hash values. Specifically, the authenticated model verification unit 1304 calculates similarity between the output when verification data is input and a predetermined output. The authenticated model verification unit 1304 may determine that a model is passed as long as it has similarity with a predetermined threshold or more. This method is effective when tolerating alteration such as a certain level of transfer learning and fine tuning with respect to an authenticated model.

### Modification 3-2: Evaluation Score Calculation Based on Authenticated Model

In the third embodiment, in the model database 1101, each authenticated model 1102 is associated with a single authenticated truthfulness score. Since the authenticated truthfulness score associated with the authenticated model 1102 is “90”, the evaluation unit 204 calculates “90” as the authenticated truthfulness score 107 of the generated output 105. However, it is conceivable that the alteration amount of the generated output 105 increases or decreases depending on a generation parameter of the authenticated model 1102, a prompt to be given, and the like. Therefore, the truthfulness score associated with each authenticated model in the model database 1101 may have a range. When calculating the authenticated truthfulness score of the generated output 105 based on the truthfulness score associated with the authenticated model 1102, the evaluation unit 204 may calculate the authenticated truthfulness score in consideration of other information.

For example, it is assumed that there is an authenticated model in which the input image 102 is not greatly altered in a normal use range, but the input image 102 is altered to a certain extent only in a case where extremely strong noise reduction is performed. In this case, the model database 1101 may set the truthfulness score associated with the authenticated model described above to 70 to 90. At this time, the evaluation unit 204 may separately calculate the truthfulness score based on the generation parameter 103 of the same authenticated model in addition to the information on the truthfulness score of 70 to 90 associated with the authenticated model.

This method enables the evaluation unit 204 to calculate the authenticated truthfulness score of the generated output in a manner reflecting actual usage of the authenticated model 1102. This enables the present modification to calculate the evaluation score for the generated output of the generative AI in a more realistic form, and therefore it is possible to improve the reliability of the evaluation score that is the authenticated truthfulness score of the generated output.

### Modification 3-3: Behavior at Time of Falsification Detection

In the third embodiment, an embodiment in a case where the client 101 performs normal generative AI processing has been described. However, it is conceivable that a malicious client transmits false information to the authentication server 106 to illegally circumvent the verification of the authenticated model 1102. Therefore, a mechanism for falsification prevention may be added to the third embodiment.

For example, at the timing when the client 101 calculates the hash value of the authenticated model 1102 for the first time, this hash value may be recorded in a log in a non-rewritable format. Thereafter, the client 101 may continue to calculate the hash value of the authenticated model 1102 at a constant cycle as background processing, and invalidate the verification result given to the authenticated model 1102 in a case of obtaining a value different from the hash value of the log. In addition, the holding control unit 207 may invalidate the storage unit 208 or corresponding information on the storage unit 208 in a case where the verification result is invalidated.

The above method enables the present modification to prevent falsification of an authentication result, and to further improve the reliability of the evaluation score that is authenticated truthfulness score for a generated output of the generative AI processing.

### Modification 3-4: Omission of Verification

In the third embodiment described above, an example in which the authentication server 106 verifies the authenticated model has been described, but in the present modification, the truthfulness score of a generated output generated by an unverified authenticated model may be held as authenticated truthfulness score.

According to the present disclosure, it is possible to improve the reliability of the truthfulness score of a generated output by the generative AI.

### Other Embodiments

The above-described embodiments may be appropriately combined. It may be configured such that the user can select any of the combined embodiments.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-224304, filed Dec. 19, 2024, which is hereby incorporated by reference herein in its entirety.

What is claimed is:

1. An information processing apparatus that holds a generated output generated by generative artificial intelligence (AI) processing, the information processing apparatus comprising:
an acquisition unit configured to acquire, from an outside, authentication information regarding an authenticated truthfulness score, which is a result of authentication of truthfulness score of the generated output; and
a holding control unit configured to hold an authenticated truthfulness score based on the authentication information in association with a generated output.

2. The information processing apparatus according to claim 1 further comprising a generation unit including an authenticated model that is a generation model associated with authentication information and outputs a generated output in the generative AI processing.

3. The information processing apparatus according to claim 2 further comprising an evaluation unit configured to calculate, as the authenticated truthfulness score, the truthfulness score of a generated output generated by the authenticated model.

4. The information processing apparatus according to claim 2 further comprising
an evaluation unit configured to calculate, based on a model truthfulness score, the authenticated truthfulness score of a generated output generated by the authenticated model associated with the model truthfulness score indicating truthfulness score of the generation model.

5. The information processing apparatus according to claim 1 further comprising an evaluation unit configured to calculates the truthfulness score of the generated output based on a difference between input data that is a processing target of the generative AI processing and the generated output.

6. The information processing apparatus according to claim 1 further comprising an evaluation unit configured to calculate the truthfulness score of the generated output based on similarity between input data that is a processing target of the generative AI processing and the generated output.

7. The information processing apparatus according to claim 1 further comprising an evaluation unit configured to calculate the truthfulness score of the generated output based on at least any of a generation model used for the generative AI processing, a prompt used for the generative AI processing, and learning data of a generation model used for the generative AI processing.

8. The information processing apparatus according to claim 1 further comprising an evaluation unit configured to calculate the truthfulness score of the generated output based on information regarding a history of input data used for the generative AI processing.

9. The information processing apparatus according to claim 1 further comprising an evaluation unit configured to calculate the truthfulness score of the generated output based on at least any of a number of times and an amount of alteration in which input data used for the generative AI processing has been processed by generative AI in past.

10. The information processing apparatus according to claim 1 further comprising an evaluation unit configured to calculate the truthfulness score of the generated output based on at least any of noise and a digital watermark added to input data used for the generative AI processing.

11. The information processing apparatus according to claim 1, wherein the acquisition unit acquires, as the authentication information, at least any of the authenticated truthfulness score, an authenticated application for executing the generative AI processing, and an authenticated model used for the generative AI processing.

12. The information processing apparatus according to claim 1 further comprising a generation unit including an authenticated application in which an application that executes the generative AI processing is authenticated.

13. The information processing apparatus according to claim 1 further comprising a storage unit configured to hold the generated output and the authenticated truthfulness score based on control of the holding control unit.

14. An authentication server further comprising:
an authentication unit configured to generate authentication information regarding an authenticated truthfulness score, which is a result of authentication of truthfulness score of a generated output generated by generative AI processing; and
a transmission unit configured to transmit the authentication information to an outside.

15. The authentication server according to claim 14, wherein the authentication unit generates the authentication information including an authenticated truthfulness score authenticated based on the generated output acquired from an outside and the truthfulness score.

16. The authentication server according to claim 14, wherein the authentication unit generates the authentication information including an authenticated application in which an application for executing the generative AI processing is authenticated.

17. The authentication server according to claim 14, wherein the authentication unit generates the authentication information including an authenticated model in which a generation model used for the generative AI processing is authenticated.

18. The authentication server according to claim 14 further comprising an evaluation unit configured to calculate truthfulness score of the generated output based on information regarding the generated output.

19. The authentication server according to claim 14 further comprising a storage unit for holding information for generating the authentication information.

20. A system comprising:
the information processing apparatus according to claim 1; and
an authentication server that generates the authentication information.

21. An information processing method that holds a generated output generated by generative artificial intelligence (AI) processing, the information processing method comprising:
acquiring, from an outside, authentication information regarding an authenticated truthfulness score, which is a result of authentication of truthfulness score of the generated output; and
holding an authenticated truthfulness score based on the authentication information in association with a generated output.

22. A non-transitory computer-readable storage medium storing a computer program that, when read and executed by a computer, causes the computer to:
acquire, from an outside, authentication information regarding an authenticated truthfulness score, which is a result of authentication of truthfulness score of the generated output; and
hold an authenticated truthfulness score based on the authentication information in association with a generated output.
